(19) United States
(12) Patent Application Publication
(10) Pub. No.: US 2014/0232871 A1
(43) Pub. Date: Aug. 21, 2014

(54) METHOD FOR MANUALLY CALIBRATING A CAMERA MOUNTED ON VEHICLE

(71) Applicant: Caterpillar Inc., Peoria, IL (US)

(72) Inventors: BRADLEY S. KRIEL, PITTSBURGH, PA (US); MATTHEW ALLAN CSENCSITS, OAKMONT, PA (US); NIGEL PETER BOSWELL, PITTSBURGH, PA (US)

(73) Assignee: Caterpillar Inc., Peoria, IL (US)

(21) Appl. No.: 14/266,953

(22) Filed: May 1, 2014

(51) Int. Cl. H04N 17/00; H04N 5/225

(52) U.S. Cl. CPC H04N 17/004; H04N 5/2259
USPC 348/148

(57) ABSTRACT

A method for manually calibrating a camera mounted on a camera mount of a vehicle is provided. According to the present disclosure, the method includes acquiring an image data in a field of view of the camera based on an actual position of the camera. The captured image data is processed to determine a current pattern based on the actual position of the camera. The image data is displayed, wherein the current pattern is superimposed on the image data. The image data is also processed to display a marker pattern in the field of view of the camera. Thereafter a pre-determined orientation and/or a pre-determined height for the camera is calculated. Further, the actual position of the camera is manually adjusted to achieve the pre-determined orientation and the pre-determined height of the camera and to align the current pattern with the marker pattern.

### TECHNICAL FIELD

The present disclosure relates generally to cameras mounted on vehicles. More specifically, the disclosure relates to a method for manually calibrating camera mounted on vehicle.

### BACKGROUND

Vehicles, such as off highway trucks, graders, and the like are used to perform various types of tasks, such as carrying or pushing loads of different kinds. These tasks may be performed in regions of poor visibility, making the task difficult for the operator. Also, the above mentioned vehicles may be remotely operated. Hence, for efficient completion of tasks, the vehicles may be equipped with a vehicle vision system. The vehicle vision system may work in coordination with one or more sensors, including one or more cameras. The one or more cameras may be used to capture a video image of the environment exterior of the vehicle. The one or more cameras may be provided on the rear and/or lateral sides of the vehicle. This may allow a driver or a remote operator to visually discern the field of view, in order to assist in parking, maneuvering the vehicle in confined spaces or for other operations. Further, the one or more cameras may be provided for collision avoidance purposes for the travelling vehicle, by providing images of the roadway conditions, display signs along the roadway or proximate to the roadway, and structure recognition.

With the use of one or more cameras, the vehicles have become increasingly popular. However, the complexity required to calibrate the cameras of the vehicle vision system has been a matter of concern.

### SUMMARY OF THE DISCLOSURE

The present disclosure relates to a method for manually calibrating a camera mounted on a camera mount of a vehicle. According to the present disclosure, the method includes capture of an image data in a field of view of the camera based on an actual position of the camera. The captured image data is processed to determine a current pattern based on the actual position of the camera. The image data is displayed along with a marker pattern in the field of view of the camera. A pre-determined orientation and a pre-determined height of the camera is calculated. In addition, the method includes manually adjusting the actual position of the camera to achieve the pre-determined orientation and pre-determined height of the camera to align the current pattern with the marker pattern.

### BRIEF DESCRIPTION OF THE DRAWINGS

FIG. 1 illustrates a side view of a vehicle with a camera calibration system, in accordance with the concepts of the present disclosure;

FIG. 2 illustrates a top view of a vehicle having a camera on a front side of the vehicle and an exemplary video feed display on a display screen, in accordance with the concepts of the present disclosure;

FIG. 3 illustrates a current pattern and a marker pattern in a non-aligned position, in accordance with the concepts of the present disclosure;

FIG. 4 illustrates the current pattern and the marker pattern in an aligned position, in accordance with the concepts of the present disclosure; and

FIG. 5 is a flow chart for a disclosed method for manually calibrating the camera mounted on the vehicle, in accordance with the concepts of the present disclosure.

### DETAILED DESCRIPTION

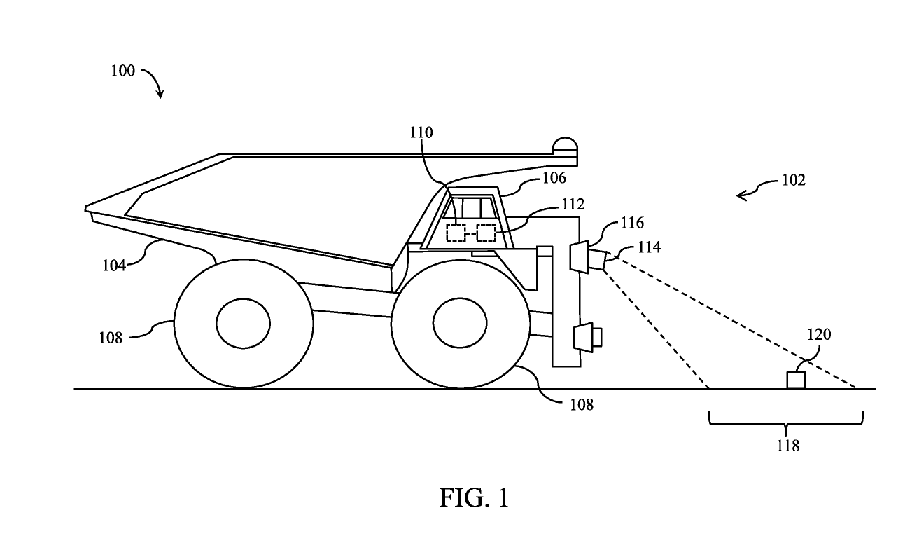

FIG. 1 illustrates a side view of a vehicle 100, in accordance to the concepts of the present disclosure. The vehicle 100 may include a camera calibration system 102, a body 104, and an operator cab 106. The body 104 may be supported by a plurality of traction devices 108. The body 104 may include the operator cab 106. The operator cab 106 may house a plurality of controls (not shown) and a display screen 110.

The camera calibration system 102 may include the display screen 110, a controller 112, a camera 114, and a camera mount 116. The controller 112 may store, record, process, and/or communicate information, provided by the camera 114, in order to control, calibrate, and/or monitor the camera 114. It can be contemplated that the controller 112 may include a memory or data storage device for storing the information received from the camera 114.

The camera 114 may be mounted on the camera mount 116, on the front side of the body 104 of the vehicle 100. In an embodiment, the camera 114 may be mounted on the rear or/and lateral sides of the body 104 of the vehicle 100. The camera 114 may work in coordination with the controller 112 to detect obstacles, avoid collisions, display external environmental elements, provide visual guidance, and/or similar purposes. The camera 114 is configured to capture image data and transmit the image data to the controller 112. The controller 112 then processes and sends the image data to the display screen 110. The display screen 110 may display the image data acquired by the camera 114. The display screen 110 may be provided in operator cab 106 for line-of-sight operation, and at a remote operation site. The camera 114 may be placed at a position referred to as an actual position of the camera 114. The actual position of the camera 114 may be a certain position characterized by a current height and/or a current orientation of the camera 114. The actual position of the camera 114 must be precisely known for processing the image data by the controller 112. The camera 114 may capture the image data of a field of view 118 which is in front side of the vehicle 100. The field of view 118 may include an object 120.

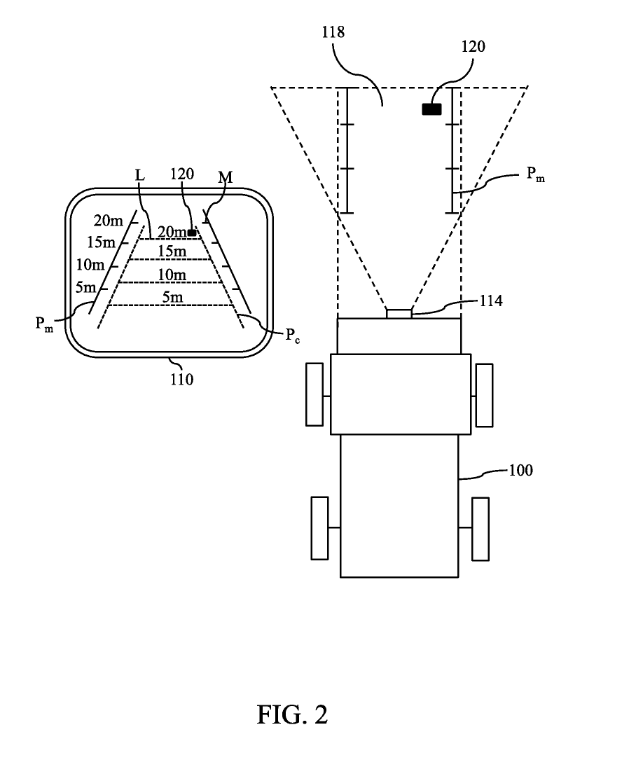

FIG. 2 illustrates a top view of the vehicle 100 having the camera 114 capturing the field of view 118, and an exemplary video feed display on the display screen 110. The field of view 118 may include a ground fore of the front side of the vehicle 100. The camera 114 may capture the image data corresponding to field of view 118 and transmits the image data to the controller 112. The controller 112, in turn, may process the image data and send a video feed to the display screen 110 for displaying the field of view 118. In addition, the controller 112 may also provide a plurality of virtual grid lines (L) which are super imposed on the displayed video feed of the image data. The grid lines (L) enable the operator to estimate the distance of the objects, such as the object 120, in the field of view 118. In one embodiment, the grid lines (L) is a cross-hair overlaid on the video feed. The operator can approximate the position and location of the object 120 based on the overlaid cross-hair. FIG. 2 also illustrates the exemplary video feed display on the display screen 110. The displayed video feed is based on the current height and/or current orientation of the camera 114. The displayed video feed, with the overlaid grid lines (L) is hereinafter referred to as a current pattern (P_{c}). It may be noted that position of the overlaid grid lines (L) on the video feed is based on current height and/or orientation of the camera 114.

Further, to calibrate the camera 114, the ground in the field of view 118 is marked with a plurality of marker lines (M), wherein each of the plurality of marker lines (M) corresponds to a definite distance from the front of the vehicle 100. For example, the marker lines (M) or a grid is drawn with a known spacing in the field of view 118. In one embodiment, cones or pylons are placed on the ground at a known spacing. Hence, the image data captured by the camera 114 also includes the image of the ground marked with the marker lines (M). The pattern of the marker lines (M) on the ground is referred to as a marker pattern (Pₘ) or calibration field.

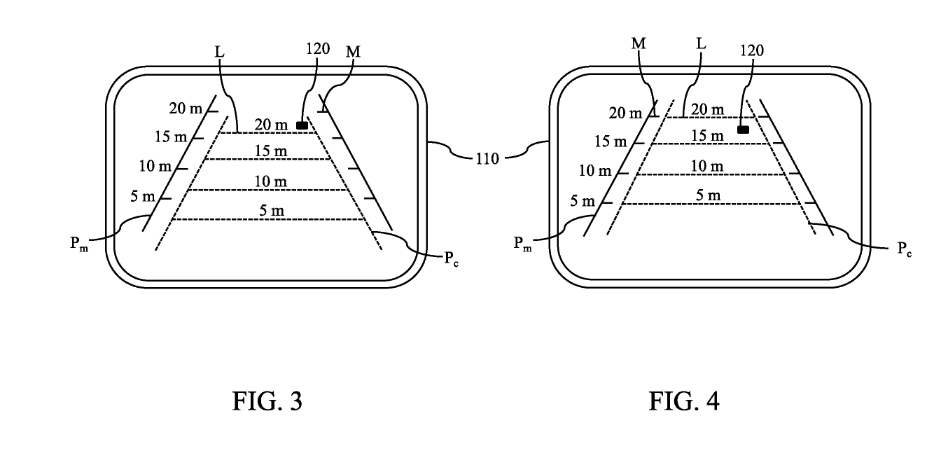

Referring to FIG. 3, the display screen 110 displays the current pattern (P_{c}) and the marker pattern (Pₘ) of the camera 114. For the actual position of the camera 114, when the camera 114 is placed at the current height and/or the current orientation, the controller 112 determines the current pattern (P_{c}). As shown in FIG. 3, the current pattern (P_{c}) is shown to include a cross hair or the grid lines (L), which enable the operator to determine distance, location, size, orientation and elevation of the object 120. The current pattern (P_{c}) determined by the controller 112 is based on the current height and/or the current orientation of the camera 114. The grid lines (L) is overlaid on the image data captured by the camera 114 and enables the operator to determine location of obstacles, road signs, pedestrians, or the like.

The location of the object 120 lying in the field of view 118 can be determined by looking at the current pattern (P_{c}) on the display screen 110. The plurality of grid lines (L) of the current pattern (P_{c}) helps in determination of distance of the object 120 from the vehicle 100. Hence, it is important to place the camera 114 at an accurate position to determine the distance of the object 120 from the vehicle 100 with accuracy. As illustrated in FIG. 3, the object 120, as per the current pattern (P_{c}) is located beyond the 20 meter (m) range, whereas, in actual, according to the marker lines (M), the object 120 is located within in the 20 m range.

For calibrating the camera 114, that is, to place the camera 114 in the desired position, the operator manually adjusts the height and orientation of the camera 114 to superimpose and align the current pattern (P_{c}) on the marker pattern (Pₘ). While manually adjusting the camera 114, the operator aims at aligning the grid lines (L) of the current pattern (P_{c}) with the marker lines (M) of the marker pattern (Pₘ), such that the marker line (M) and grid line (L) aligned with each other correspond to same distance from the vehicle 100. The operator can ensure that superimposition of the current pattern (P_{c}) on the marker pattern (Pₘ) is accurate by checking the location of the object 120 shown on the display screen 110. In other words, on the display screen 110, the object 120 in the field of view 118 should be shown at a same distance according to each of the current pattern (P_{c}) and the marker pattern (Pₘ).

Referring to FIG. 3, the display screen 110 shows a non-aligned superimposition of the current pattern (P_{c}) on the marker pattern (Pₘ). For example, the grid lines (L) correspond to distances 5 meters, 10 meters, 15 meters, and 20 meters, as shown in FIG. 3. Similarly, the marker pattern (Pₘ) includes the marker lines (M) on the ground corresponding to distances 5 meters, 10 meters, 15 meters, and 20 meters. For calibration of the camera 114, the operator adjusts the height and orientation of the camera 114 to align the grid lines (L) for the distance of 5 meters, 10 meters, 15 meters, and 20 meters on the current pattern (P_{c}) with the marker lines (M) corresponding to 5 meters, 10 meters, 15 meters, and 20 meters, respectively on the maker pattern (Pₘ).

In an embodiment, the calibration of the camera 114 is done on the basis of the object 120 in the field of view 118. As an example, assuming the accurate location of the object 120 is at a distance of 17 meters from the vehicle 100, according to the marker pattern (Pₘ), as shown in FIG. 3. By looking at the display screen 110 and referring to the current pattern (P_{c}), the operator determines that the object 120 is at a distance beyond 20 meters from the vehicle 100. This implies that the camera 114 requires calibration and hence, the operator moves the camera 114 manually to place the camera 114 at the desired position. Thereafter, the operator calculates a pre-determined height and pre-determined orientation of the camera 114. In an embodiment, the pre-determined height and pre-determined orientation of the camera 114 can be calculated based on known trigonometric function. Further an automated system can be applied to calculate and indicate the pre-determined height and pre-determined orientation of the camera 114 to the operator. Thereafter, the operator manually adjusts the current height and/or the current orientation of the camera 114 to attain the pre-determined height and pre-determined orientation of the camera 114 or until the display screen 110 shows an aligned superimposition of the current pattern (P_{c}) on the marker pattern (Pₘ), as shown in FIG. 4. The aligned superimposition of the current pattern (P_{c}) on the marker pattern (Pₘ) implies that the object 120 is shown at a distance of 17 meters from the vehicle 100, according to both the current pattern (P_{c}) and the marker pattern (Pₘ). At this point, the camera 114 is at the desired position for efficient operation.

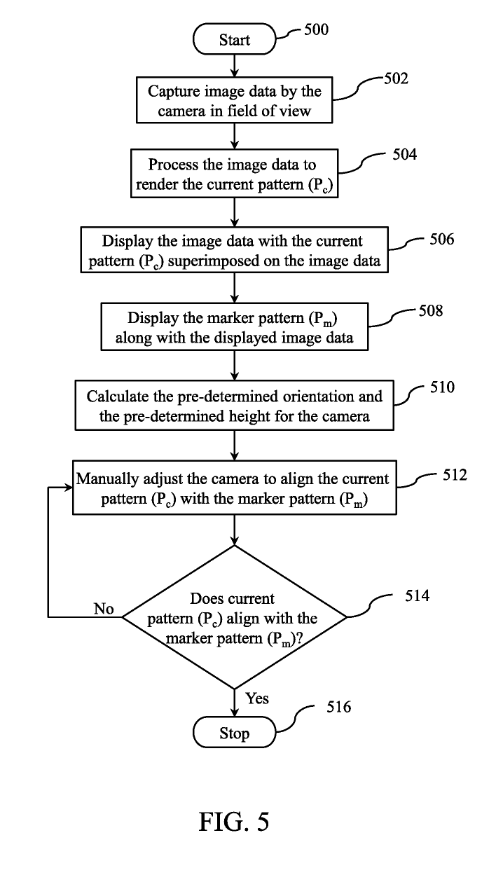

FIG. 5 is a flow chart for the disclosed method for manually calibrating the camera 114 mounted on the vehicle 100. At step 500, the method starts when the vehicle 100 reaches in proximity of the field of view 118. The method proceeds to step 502.

At step 502, the image data is captured by the camera 114 based on the actual position of the camera 114. The image data is received by the controller 112. The method proceeds to step 504.

At step 504, the controller 112 processes the image data and determines the current pattern (P_{c}) based on the actual position of the camera 114. The actual position of the camera 114 is the current height and/or the current orientation of the camera 114. The method proceeds to step 506.

At step 506, the captured image data is displayed on a display unit, such as display screen 110. Further, the displayed image data is superimposed by the current pattern (P_{c}), such that the current pattern (P_{c}) is in form of a cross hair or grid line (L) overlaid on the displayed image data. Thereafter, the method proceeds to step 508.

At step 508, the controller 112 displays the marker pattern (Pₘ) in the field of view 118. The marker patter (Pₘ) along with the image data is captured and displayed on the display screen 110. The method proceeds to step 510.

At step 510, the pre-determined orientation and the pre-determined height for the desired position of the camera 114 are calculated and the method proceeds to step 512.

At step 512, the current pattern (P_{c}) is superimposed on the marker pattern (Pₘ) by manually adjusting the current height and/or the current orientation to achieve the pre-determined height and the pre-determined orientation of the camera 114. The superimposing event is displayed on the display screen 110. The method proceeds to step 514.

At step 514, it is checked if the current pattern (P_{c}) aligns with the marker pattern (Pₘ). If the current pattern (P_{c}) does not align with the marker pattern (Pₘ), the method proceeds to step 512. If the current pattern (P_{c}) aligns with the marker pattern (Pₘ), the method terminates at step 516.

At step 516, the method ends with the calibration completed by the camera calibration system 102. At this point, the camera 114 has attained the desired position.

### INDUSTRIAL APPLICABILITY

The disclosed camera calibration system 102 is provided for calibration of the camera 114 on the vehicle 100. When operating the vehicle 100 the camera 114 captures the image data of the field of view 118, while the camera 114 is at the actual position. During the calibration mode, the controller 112 determines the current pattern (P_{c}), based on the actual position of the camera 114. The controller 112 also determines the marker pattern (Pₘ), based on the captured image data by the camera 114. The marker pattern (Pₘ) includes the plurality of marker lines (M) which are marked on the ground of the field of view 118, ahead of the vehicle 100. The disclosed camera calibration system 102 allows the operator to ensure that the camera 114 is in a correct position for sending accurate information to the controller 112 by superimposing the current pattern (P_{c}) on the marker pattern (Pₘ). In situations, with the help of the display screen 110, when the operator determines that the current pattern (P_{c}) does not align with the marker pattern (Pₘ), the operator manually adjusts the current orientation and the current height of the camera 114. The operator continues to move the camera 114 until the object 120 in the field of view 118 is shown at the same distance in the marker pattern (Pₘ) as that in the current pattern (P_{c}). In other words, the operator moves the camera 114 to align the plurality of grid lines (L) of the current pattern (P_{c}) with the plurality of marker lines (M) of the marker pattern (Pₘ), such that the marker line (M) and the grid line (L) are aligned with each other and correspond to same distance from the vehicle 100.

The existing method of camera calibration involves a number of complex calculations to set the camera 114 in the desired position. The proposed method of manual calibration reduces the number or instances of complex calculations, which are required in the existing calibration method. The disclosed method also includes a limited number of calculations to map out the marker pattern (Pₘ), by determining the pre-determined height and the pre-determined orientation, corresponding to the desired position of the camera 114.

The present description is for illustrative purposes only and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claim.

What is claimed is:

1. A method for manually calibrating a camera mounted on vehicle, the method comprising:
capturing an image data in a field of view of the camera based on an actual position of the camera;
processing the image data to render a current pattern based on the actual position of the camera;
display the image data, wherein the current pattern is superimposed on the displayed image data;
display a marker pattern in the field of view of the camera along with the displayed image data;
calculating a pre-determined orientation and a pre-determined height of the camera; and
manually adjusting the actual position of the camera to achieve the pre-determined orientation and the pre-determined height of the camera to align the current pattern with the marker pattern.
